(19) United States
(12) Patent Application Publication
(10) Pub. No.: US 2023/0389162 A1
(43) Pub. Date: Nov. 30, 2023

(54) SENSING USER PRESENCE FOR AUTOMATED LIGHTING SYSTEMS

(71) Applicant: SIGNIFY HOLDING B.V., Eindhoven (NL)

(72) Inventor: TEWE HIEPKE HEEMSTRA, VELDHOVEN (NL)

(21) Appl. No.: 18/032,623

(22) PCT Filed: Oct. 15, 2021
(86) PCT No.: PCT/EP2021/078666

§ 371 Date: Apr. 19, 2023

(30) Foreign Application Priority Data
Oct. 20, 2020 (EP) 20202804.9

(51) Int. Cl. H05B 47/12

(52) U.S. Cl. CPC H05B 47/12

(57) ABSTRACT

A mechanism for detecting user presence. A computing system generates a sound wave having a predetermined pattern responsive to the existence of user activity with the computing system, the predetermined pattern being located in an inaudible part of the sound wave and/or being formed of an imperceptible audio watermark. A user presence sensor receives the sound wave and detects the presence or existence of the predetermined pattern. An output signal, responsive to this detection, is output to a light control system which controls the operation of one or more lighting units responsive to the output signal. The operation of one or more lighting units is thereby responsive to a user interaction with a computing system.

### FIELD OF THE INVENTION

The present invention relates to the field of automated lighting solutions, and in particular to sensor systems for use in automated lighting solutions.

### BACKGROUND OF THE INVENTION

In the field of automated lighting systems, there is an increasing use of motion or movement sensors which, in response to detecting a movement, trigger the turning/switching on of one or more lights. A typical motion sensor is the passive infrared (PIR) sensor, which detects motion based on the pyroelectric effect. In particular, a PIR sensor detects specific changes in the pattern of infrared radiation incident thereon, which would indicate movement of an individual in the vicinity of the PIR sensor.

In order to save energy, it is typical for such lighting systems to implement a timeout trigger, where the one or more lights are switched off if no motion is detected (e.g. by the PIR sensor) for a predetermined period of time.

However, this can result in a situation in which, if an individual makes insufficient movement during this predetermined period of time, the light(s) are switched off despite the individual still desiring/needing light. This situation is fairly common in office/work environments, or in bathroom facilities, where movement of individuals is reduced. This can frustrate/inconvenience the individual, requiring them to make movements, such as using their arms or by standing up and moving, in order to reactivate the light(s).

To reduce the effect of this nuisance, it is possible to extend the timeout period to reduce the likelihood that the light(s) will be switched off or to reduce the number of times that an individual is inconvenienced. However, this will reduce energy savings.

There is therefore a desire for an improved mechanism for keeping the light(s) on, whilst minimizing any effect on energy savings.

### SUMMARY OF THE INVENTION

The invention is defined by the claims.

According to examples in accordance with an aspect of the invention, there is provided a user presence sensor for an automated lighting system.

The user presence sensor comprises: an acoustic sensor configured to receive sound waves; a signal processing module configured to determine whether or not a predetermined pattern exists in an inaudible part of received sound waves and/or as an imperceptible audio watermark in received sound waves; and an output module configured to, in response to the signal processing module determining that a predetermined pattern exists in a received sound wave, generate an output signal that indicates the presence of an individual in the vicinity of the acoustic sensor, wherein sound waves having the predetermined pattern are generated by a sound generating module of a computing system in response to the existence of an interaction between the individual and the computing system.

In the context of the present invention, inaudible is used to mean outside the range of human hearing, e.g. in terms of frequency, sound pressure and/or amplitude. An imperceptible audio watermark is a pattern embedded in a sound wave that is imperceptible to human hearing (but can be detected using signal processing means). Thus, in general the predetermined pattern forms an imperceptible (to human hearing) part of the received sound waves. In effect, this means that a sound wave having the predetermined pattern is indistinguishable (by a human) from a sound wave not having the predetermined pattern. This effect is achieved by placing the predetermined pattern in an inaudible part of a sound wave and/or using an imperceptible audio watermarking approach.

Approaches for quantitatively assessing whether an audio watermark is “imperceptible” or not are well established in the field. For instance, perception models (e.g. codec listening tests) are used in audio coding standards, such as the MP3 standard (ISO/IEC 11172-3:1993) or the AAC standard.

As another example, an audio watermark may be considered imperceptible if a difference in quality (e.g. a signal to noise ratio) of the sound wave carrying the audio watermark and an otherwise identical sound wave not carrying the audio watermark differ by less than a predetermined value.

It is proposed to use inaudible/imperceptible parts of sound waves to communicate the presence of an individual within a particular area, by using a computing system to generate sound waves having a predetermined pattern within the inaudible/imperceptible parts of the sound waves. This can indicate that a user is interacting with the computing system, and is therefore present in an area surrounding the computing system.

The present disclosure thereby provides a mechanism for detecting the presence of an individual without relying upon (large) movement(s) of the individual or upon potentially complex communications between computing systems and lighting systems, which would require significant modifications to the computing system to be able to communicate with automated lighting systems. The use of inaudible/imperceptible parts of sound waves means that a communication can be made between the computing system and the automated lighting system without disturbing the individual.

The computing system is configured to generate sound waves having the predetermined pattern (as an audio watermark and/or in an inaudible part of the sound wave(s)) in response to the existence of an or any interaction of the user with the computing system. The content of the interaction is immaterial, rather only the existence of the interaction triggers the generation of one or more sound waves having the predetermined pattern. Thus, if an interaction exists, a sound wave is generated by the computing system.

In other words, the interaction is any interaction of the user with an input interface of the computing system, e.g. not necessitating the input of any particular information by the user.

The present disclosure recognizes that the content of an interaction between the user and a computing system is immaterial to whether or not the automated lighting system should provide lighting for the user as, for automated lighting system, this should simply be dependent upon user presence. Thus, relying upon the existence of an interaction to identify the presence of an individual provides a reliable and low-complexity mechanism for triggering control of light.

The predetermined pattern may be one of a set of predetermined patterns. Thus, different predetermined patterns may be included in the inaudible part of the sound wave(s) and/or as different imperceptible audio watermarks. Different predetermined patterns may be used, for example, to communicate different types of information between the computing system and the user presence sensor, e.g. to identify the computing system and/or a user of the computing system. Other forms of information may be encoded/modulated/watermarked into the (inaudible part of) the sound wave(s).

In some examples, the inaudible part of each received sound wave comprises an ultrasound and/or infrasound part of received sound waves. Thus, the predetermined pattern may exist in parts of the sound waves that are outside the threshold of human hearing (e.g. outside frequency ranges perceptible by humans). The generally accepted range of frequencies audible to humans, the “hearing range”, is between 20 Hz and 20,000 Hz. However, other forms of inaudible parts of sound waves are plausible, such as a part of a sound wave having a magnitude below the threshold of human hearing or a sound pressure below a certain magnitude.

The output signal may be configured to control, e.g. when appropriately processed by a light control system, whether (and preferably which) one or more lighting units operate in a first mode or a second, different mode based on whether a predetermined pattern is identified in the inaudible parts of a received sound wave. The characteristics of light output in the first mode and in the second mode differ (e.g. have different intensities, colors, temperature, angles, spread and so on).

In particular examples, the output signal may trigger, if the sound wave(s) contain(s) the predetermined pattern in an inaudible part and/or as audio watermark, the activation of one or more lighting units. Activation here means the turning on or switching on of a lighting unit so that it outputs light (e.g. at or above some predetermined threshold). Deactivated lighting units do not emit light (or emit light below some predetermined threshold).

Of course the output signal may trigger more complex control of the automated lighting system, e.g. employing a particular policy, such as an “if-this-then-that” policy, in order to determine how to control the output of light by lighting units of the lighting system.

In one example, the predetermined pattern may be a burst of acoustic energy at a predetermined frequency, within a predetermined range of frequencies or (at) a predetermined set of two or more frequencies. A burst or chirp of acoustic energy provides a simple, reliable and readily detectable mechanism for communicating the existence of an interaction (between a user and a computing system) to the user presence sensor. Other suitable predetermined patterns (e.g. temporal patterns) could be used in further/other embodiments. In these examples, the predetermined frequency and/or frequencies may be in inaudible parts (e.g. ultrasound, infrasound) of the sound wave(s).

In another example, the predetermined pattern may be a modulation pattern, such as a spread-spectrum modulation pattern, which is preferably encoded using a predetermined modulation protocol. This facilitates the transmission of (digital) information between the computing system and the user presence sensor for more complex control of the automated lighting system. In other words, the computing system may encode or modulate information into an inaudible (or imperceptible) part of a sound wave in the form of a predetermined pattern. Thus, the predetermined pattern may comprise or be encoded/modulated information, e.g. information encoded according to some predetermined modulation/communication protocol.

In some examples, the predetermined pattern is a predetermined audio watermark for transmitting of information. This is effectively a modulation pattern for modulating the sound wave whilst remaining imperceptible to human interpretation.

Optionally, the signal processing module is configured to, in response to the acoustic sensor determining that a predetermined pattern exists in a received sound wave, generate identifying information of the predetermined pattern determined to exist in each received sound wave; and the output module may be configured to generate the output signal to provide the generated identifying information.

Outputting information that identifies the predetermined pattern facilitates identification of the computing system that generated the sound wave having the predetermined pattern. This can allow policies for defining which lighting units are controlled based on an identified computing system to be implemented.

In some examples, the signal processing module is further configured to, for sound waves having the predetermined pattern, determine a distance value responsive to a distance between the computing system that generated the sound wave having a predetermined pattern and the acoustic sensor; and the output module is further configured to, in response to the acoustic sensor determining that a predetermined pattern exists in a received sound wave, provide an indication of the determined distance value between the computing system that generated the sound wave having the predetermined pattern and the acoustic sensor.

The distance value may, for instance, represent an amplitude or signal strength of the predetermined pattern in the received sound wave. In examples, a relative amplitude or signal strength of the predetermined pattern in the received sound wave received by neighboring user presence sensors may provide an indication of the user presence sensor being ‘closest’ to the computing system. In other examples, a distance may be determined using a suitable distance determination mechanism such as a phased array processing technique. A yet alternative approach could be to determine a time-of-flight measure as the distance value, e.g. by identifying a timestamp included in a received sound wave having the predetermined pattern.

An indication of a determined distance can be useful for selecting which of a plurality of lighting units to control (e.g. be activated) based on known relationships between the acoustic sensor and the lighting units. In particular, it is possible to only control those lighting units which are proximate to sensors near the computing system that generated the sound wave, e.g. lighting units which are proximate to a user presence sensor having a distance value indicating that the computing system is near the user presence sensor or a user presence sensor having a distance value indicating that it is closest (relative to other user presence sensor) to the computing system.

In some embodiments, the signal processing module is further configured to, for sound waves having the predetermined pattern, determine a position of the computing system that generated the sound wave having the predetermined pattern; and the output module is further configured to, in response to the acoustic sensor determining that a predetermined pattern exists in a received sound wave, provide an indication of the determined position of the computing system that generated the sound wave having the predetermined pattern.

The position may be determined from information comprised in the encoded/modulated/watermarked (inaudible part of) the sound wave(s). The position may also be determined via triangulation/trilateration methods between multiple user presence sensors receiving the (inaudible part of) the sound wave(s).

There is also proposed an automated lighting system comprising: a user presence sensor as herein described, one or more lighting units configured to controllably output light; and a light control system configured to receive the output signal from the user presence sensor and control the operation of the one or more lighting units responsive to the output signal. In particular, the light control system may be configured to control one or more characteristics of the light output by the one or more lighting units, such as an ON/OFF state, a light intensity, a light spread, a light color, a light temperature, a light angle (i.e. an angle at which light is output by a lighting unit) and so on. Other suitable (light) characteristics would be apparent to the skilled person.

In some examples, the light control system is configured to determine which of the one or more lighting units to control responsive to the identifying information of the predetermined pattern in the output signal.

The light control system may be configured to: process the identifying information to identify the computing system that generated the sound wave having the predetermined pattern; and select which one or more lighting units to control responsive to the identified computing system.

In some examples, the light control system is configured to control one or more lighting units responsive to the determined distance between the computing system that generated the sound wave having the predetermined pattern and the user presence sensor. In particular, the light control system may be configured to select which one or more lighting units to control responsive to the determined distance and/or control one or more (light) characteristics of light output by the one or more lighting units responsive to the determined distance. The light control system may be configured to control a first set of one or more lighting units, the first set of one or more lighting units being the most proximate to the computing system that generated the sound wave having the predetermined pattern.

In some examples, the light control system is configured to select which of the one or more lighting units to control responsive to the determined position of the computing system that generated the sound wave having the predetermined pattern and the user presence sensor.

There is also proposed a processing module for a computing system for generating sound waves detectable by any user presence sensor or any automated lighting system herein described. The processing module is configured to: receive, from an input interface, an indication of whether or not a user is interacting with the computing system; and output a control signal to control a sound generating module to generate and transmit a sound wave, having a predetermined pattern in an inaudible part of the sound wave or as an imperceptible audio watermark in the sound wave, in response to the user interacting with the computing system.

In particular, the processing module may be configured to output a control signal to control the sound generating module to generate and transmit a sound wave, having an inaudible or imperceptible predetermined pattern, in response to any interaction between the user and the computing system. The processing module may be part of or integral with the computing system and use an audio speaker of the computing system (if present) to output a sound wave having a predetermined pattern in an inaudible part of said sound wave and/or an imperceptible audio watermark in said sound wave.

In alternatively example, the processing module and sound generating module may be comprised in a separate audio device adapted to be communicatively connected to the computing system to receive a signal indicative of whether or not a user is interacting with the computing system and outputting a sound wave having a predetermined pattern in an inaudible part of said sound wave and/or an imperceptible audio watermark in said sound wave. The audio device may be implemented as a dongle or a USB device for the computing system. Such audio device may be considered a peripheral device to the computing system that is operationally part of the computing system.

The processing module and the user presence sensor are a plurality of interrelated products, e.g. the former acting as a transmitter and the second acting as a receiver. In particular, the two pieces of apparatus complement one another and work together to achieve the disclosed concept. Accordingly, there is also provided a “kit of parts” comprising the processing module and the user presence sensor. The processing module may be provided as a software package (stored on a storage device and downloadable to the computing system or available as an application or driver stored on a server and downloadable to the computing system from that server) to be installed on the computing system. As described above, alternatively, the “kit of parts” comprises the processing module and the sound generating module (provided as a separate audio device) and the user presence sensor.

The processing module may be configured to encode/modulate information into the predetermined pattern, e.g. select a predetermined pattern and/or imperceptible audio watermark that corresponds to particular, desired information. In other words, the processing module may be configured to select or determine a predetermined pattern for an inaudible part of the sound wave and/or an imperceptible audio watermark based on desired communication information. The desired communication information may, for instance, comprise an identity of the computing system and/or an identity of the user of the computing system.

Thus, a predetermined pattern may be information encoded and/or modulated (and optionally encrypted) according to some predetermined modulation/communication protocol.

The processing module is configured output a control signal to control the sound generating module to generate and transmit a sound wave having the predetermined pattern in an inaudible part of the sound wave and/or as an imperceptible audio watermark, wherein the predetermined pattern is repeated at a frequency no greater than a predetermined maximum frequency. In other words, there may be a minimum time interval between consecutive emissions of a sound wave having the predetermined pattern.

This approach avoids a sound wave having the predetermined pattern from being constantly transmitted, which can help reduce interference with other computing systems (also outputting their own sound waves) and reduces processing power requirements. The automated lighting system and/or sensor may continue to operate on a timeout mechanism, meaning that continual generation of sound waves having the predetermined pattern may be superfluous and waste energy and bandwidth.

There is also proposed an automated lighting arrangement comprising any automated lighting system herein described and any one or more audio modules or audio devices herein described. The automated lighting arrangement may comprise one or more computing systems having the one or more audio modules or audio devices.

There is also proposed a method of sensing the presence of an individual (for an automated lighting system). The method comprises: receiving sound waves at an acoustic sensor; determining whether or not a predetermined pattern exists in an inaudible part of each received sound wave and/or as an imperceptible audio watermark in received sound waves; and in response to determining that a predetermined pattern exists in a received sound wave, generating an output signal that indicates the presence of an individual in the vicinity of the acoustic sensor, wherein sound waves having the predetermined pattern are generated by a computing system in response to the individual interacting with the computing system.

The above proposed solutions operate in the assumption the that sound(s) generated by the computing system are detectable by the user presence sensor. In a particular case where the sound generating module is bypassed, disabled, covered or in any other way prevented from emitting a sound indicative of an interaction of the user with the computing system into the environment, the the acoustic sensor of the user presence sensor is unable to sense or pickup such sound indicating interaction of the user with the computing system. An example would be a situation wherein a user headphone is connected to the computing system (e.g. inserted in an input jack of a laptop or wireless connected to the computing system) and the computing system automatically disables the internal speakers of the computing system in favor of the headphone speakers. Another example would be a situation wherein the computing system is a laptop and the lid of laptop is closed, e.g. when the laptop is connected to a docking station, and wherein the lid covers the internal speakers of the laptop. In the above exemplary situations, sounds generated by the sound generating module internal to the computing system will not or bearly be detectable by the acoustic sensor of the user presence sensor. In order to verify the proper operation of the computing system for use with a user presence sensor or lighting system as described herein, in examples, an audio response received by an internal microphone of the computing system, in response to a sound generated by the internal speaker of the computing system, is checked. If the internal microphone detects a response, then the interal speaker of the computing system is ‘free’ and sounds emitted by the internal speaker may be detected by the user presence sensor. However, if the internal microphone detects no response or a response below a minimum threshold volume level, the the interal speaker of the computing system is ‘covered’ or ‘disabled’ and sounds emitted by the internal speaker or emitted by a connected headphone speaker may not be detected by the user presence sensor. Any type of sound may be used to execute this check, including a sound having a predetermined pattern in an inaudible part thereof and/or an imperceptible audio watermark. Alternatively, the sound may be a sound generated by an operating system of the computing system (e.g. a system sound indicating that a headphone is being connected or a log-in sound). As a result of a failing audio response check, the user may be warned that the computing system is not able to notify presence of the user to the automated lighting system.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 illustrates an automated lighting arrangement;

FIG. 2 illustrates a user presence sensor for an automated lighting arrangement;

FIG. 3 illustrates an automated lighting system for an automated lighting arrangement;

FIG. 4 illustrates a computing system for an automated lighting arrangement;

FIG. 5 illustrates the frequency content of a sound wave; and

FIG. 6 illustrates a method according to an embodiment.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a mechanism for detecting user presence. A computing system generates a sound wave having a predetermined pattern responsive to the existence of user activity with the computing system, the predetermined pattern being located in an inaudible part of the sound wave and/or being formed of an imperceptible audio watermark. A user presence sensor receives the sound wave and detects the presence or existence of the predetermined pattern. An output signal, responsive to this detection, is output to a light control system which controls the operation of one or more lighting units responsive to the output signal. In this way, the operation of one or more lighting units is responsive to a user interaction with a computing system.

Embodiments are based on the realization that motion sensors, commonly used to detect user presence, are not very effective when the user is near-stationary (e.g. when working at a computer or the like). Instead, it is proposed to use a user interaction with a computing system as a trigger for controlling lights. In particular, the existence of a user interaction identifies the presence of a user. Information on this existence is passed to a light control system using inaudible parts of sound waves and/or imperceptible audio watermarks, to communicate without disturbing the individual.

Embodiments can be employed in any suitable lighting system, and is particularly advantageous in environments in which users can be largely stationary, but still interacting with computing systems, such as in offices, or where thermal movement is masked, such as in some industrial environments or laboratories.

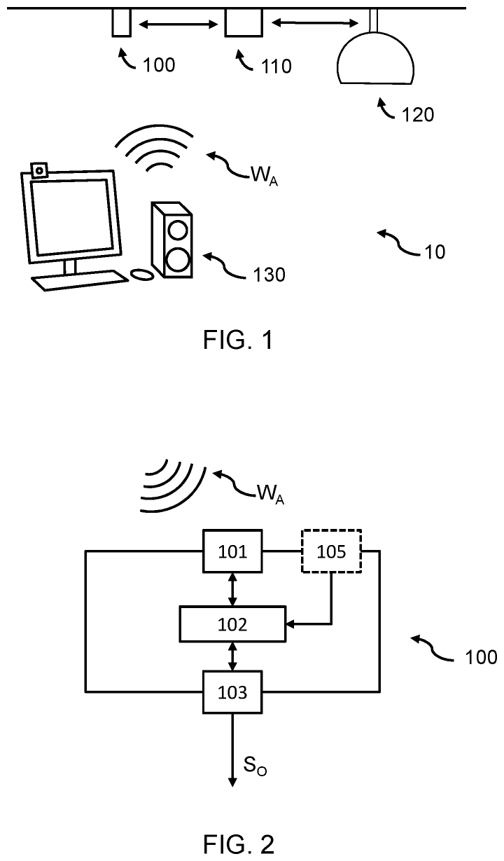

FIG. 1 illustrates an automated lighting arrangement 10 for understanding a context of the invention. The automated lighting arrangement comprises a user presence sensor 100, a light control system 110, a lighting unit 120 and a computing system 130. The user presence sensor 100, light control system 110 and lighting unit 120 together form an automated lighting system.

The computing system 130 is configured, upon detecting the existence of an interaction between a user interface of the computing system and a user, to generate an acoustic/sound wave W_{A} having a predetermined pattern in an inaudible part and/or an acoustic/sound wave W_{A} as an imperceptible audio watermark.

In the context of this disclosure, “inaudible” is used to mean outside the range of human hearing, e.g. in terms of frequency, sound pressure and/or amplitude. For instance, the ultrasound frequency range (>20 kHz) represents a first inaudible part of a sound wave. The infrasound frequency range (<25 Hz, or more preferable <20 Hz) represents a second inaudible part of a sound wave. As another example, parts of a sound wave below the absolutely threshold of hearing, such as the part of a sound wave at a sound pressure of less than 20 pPa, are considered inaudible, and could form an inaudible part of the sound wave. Other suitable inaudible parts of a sound wave will be apparent to the skilled person.

An imperceptible audio watermark is a mechanism for watermarking or fingerprinting a sound wave, in which the presence or absence of the watermark is imperceptible to human hearing. Thus, if two sound waves are provided to a human, only one of which contains an imperceptible audio watermark but is otherwise identical to the other sound wave, then both sound waves will be perceptually indistinguishable. Standard mechanisms for testing the imperceptibility of an audio watermark are well established, such as those described by standard codec listening tests, such as those employed by one or more audio compression standards, e.g. the MP3 standard or the AAC standard.

Approaches for providing an imperceptible audio watermark usually rely upon modulations, modification or adjustment of a sound wave which are beyond the sensitivity of human hearing system. This can be performed, for example, by making slight amplitude adjustments (e.g. ±3 dB or ±6 dB) to specific parts of a frequency, or the insertion of echoes with a delay less than a predetermined length of time (e.g. 100 ms).

Yet other mechanisms for providing an imperceptible audio watermark will be readily apparent to the skilled person, such as those suggested and described by Kim, Hyoung Joong, et al. “Audio watermarking techniques.” Intelligent watermarking techniques 7 (2004): 185. or Tarhda, Mohamed, Rachid Elgouri, and Laamari Hlou. “Audio Watermarking Systems-Design, Implementation and Evaluation of an Echo Hiding Scheme Using Subjective Tests and Common Distortions.” International Journal of Recent Contributions from Engineering, Science & IT (iJES) 1.2 (2013): 27-36.

Thus, the term “imperceptible audio watermark” is considered to have a well-established and clear term in the relevant technical field, and would be readily apparent to the skilled person.

Further examples for assessing the imperceptibility of an audio watermark usually employ a listening test, such as those disclosed by Neubauer, Christian, and Jirgen Herre. “Digital watermarking and its influence on audio quality.” Audio Engineering Society Convention 105. Audio Engineering Society, 1998 or Maha, Charfeddine, et al. “DCT based blind audio watermarking scheme.” 2010 International conference on signal processing and multimedia applications (SIGMAP). IEEE, 2010.

These documents also disclose approaches for performing imperceptible audio watermarking. Another suitable approach could be to use a spread-spectrum sequence as the predetermined pattern and/or audio watermark, such as those presented by D. Kirovski and H. S. Malvar, “Spread-spectrum watermarking of audio signals,” in IEEE Transactions on Signal Processing, vol. 51, no. 4, pp. 1020-1033, April 2003. Another suitable algorithm is suggested by Al-Haj, Ali. “An imperceptible and robust audio watermarking algorithm.” EURASIP Journal on Audio, Speech, and Music Processing 2014.1 (2014): 37.

Thus, activity by the user with the computing system causes the generation of a sound wave having a predetermined pattern in an inaudible part of the sound wave and/or a sound wave as an imperceptible audio watermark (which may be collectively referred to hereinafter as “imperceptible predetermined pattern” or simply “predetermined pattern”, unless specifically identified individually).

The computing system may comprise any suitable consumer computing equipment having a speaker or other sound generating module suitable for generating and transmitting sound waves. Examples of suitable consumer computing equipment include: a personal computer; a laptop; a smartphone; a tablet; a human-interface device (such as a mouse or keyboard); and so on. The computing system may be configured to comprise a processing module (e.g. a piece of software) and a sound generating module configured for generating the acoustic/sound wave, e.g. by controlling a speaker of the computing system, having the predetermined pattern in an inaudible part and/or as an imperceptible audio watermark, responsive to the existence of a user interaction with the computing system. Additional information on embodiments for the computing system is provided later in the description.

The generated sound wave may, for example, be (part of) a sound wave that is already being generated by the computing system, e.g. if it is playing music or the like, or may be a completely new sound wave.

Of course, if a completely new sound wave is generated, some further steps may be taken to ensure that the predetermined pattern is inaudible or imperceptible to the individual.

For instance, if a completely new sound wave is generated, the computing system may sense the background noise near the user (e.g. via one or more microphones) or may assume a default background noise level. The computer-system may then generate a sound wave at a volume below the background noise level (e.g. to be imperceptible to the user). This approach is particularly advantageous if imperceptible audio watermarks are employed.

The user presence sensor 100 is configured to receive sound waves, e.g. monitor for sound waves, and detect or monitor for the presence or existence of the predetermined pattern in the inaudible part of any received sound wave or imperceptible audio watermark in any received sound wave. In response to detecting the existence of the predetermined pattern or audio watermark, the user presence sensor generates an output signal that indicates an individual is in the vicinity of the user presence sensor 100.

In some examples, different imperceptible predetermined patterns (e.g. different audio watermarks) are used to convey different pieces of information between a computing system and the user presence sensor, as explained in more detail below. Thus, a predetermined pattern may be information encoded and/or modulated according to some predetermined modulation/communication protocol. In some examples, the user presence sensor may therefore monitor for the presence or existence of any of a set of predetermined patterns, which set may include all possible predetermined patterns for computing systems in the vicinity of the automated lighting system. In particular, the set may include all possible patterns according to a protocol for the communication of information.

The user presence sensor 100 therefore detects the presence of an individual within the vicinity of a computing system by monitoring for the occurrence of a predetermined pattern in inaudible (to a human) parts of acoustic signals generated by a computing system with which the user interacts and/or an imperceptible (to a human) audio watermark. This provides an accurate mechanism for detecting user presence that does not directly rely upon detecting movement of the user (e.g. as occurs with traditional PIR motion sensors).

The user presence sensor 100 passes the generated output signal to the light control system 110. The light control system 110 controls the operation of one or more lighting units, such as the lighting unit 120, based on the generated output signal. In particular, the light control system 110 controls the light output by the one or more lighting units based on the generated output signal.

For example, the light control system 110 may control which lighting units are activated (e.g. switched on, i.e. to emit light) or deactivated (e.g. switched off, e.g. to not emit light). Generally, an activated lighting unit emits light having an intensity no less than a first magnitude, a deactivated lighting unit emits light having an intensity no greater than a second, lower magnitude. The second, lower magnitude may be zero (for improved energy saving) or may be non-zero (e.g. to provide a low-level of light for safety or emergency procedures).

In other examples, the light control system 110 may control other output characteristics of the one or more lighting units, such as intensity, color, color temperature, angle and so on. The light control system 110 may be configured to control the operation of particular lighting units based on the output signal received from the user presence sensor.

In particular, the light control system 110 may control whether one or more lighting units operate in a first mode or a second mode based on the existence or non-existence of an imperceptible predetermined pattern in the output signal S_{O} (see FIG. 2). The first mode may define first lighting characteristics for the one or more lighting units and the second mode may define second, different lighting characteristics for the one or more lighting units.

In further examples, as explained below, the light control system 110 may determine which one or more lighting units to control based on information obtained in the output signal S_{O}. In some examples, the light control system 110 may be configured to determine which one or more lighting units to control based on the user presence sensor 100 from which the output signal S_{O} is received (e.g. if the light control system receives multiple different output signals from different user presence sensors).

Methods of controlling the light output by a lighting unit (e.g. whether the lighting unit is activated or deactivated) are well known to the skilled person, e.g. using command signals, controlling voltages and/or disconnecting lighting units, and will not be described for the sake of brevity. Similarly, suitable lighting units would be well known to the skilled person, and may comprise halogen lamp based lighting units, LED based lighting units, fluorescent lamp based lighting units and so on.

The automated lighting arrangement 10 therefore has the overall effect of controlling the light provided by the lighting unit(s) of the automated lighting arrangement 10 responsive to the existence of a user interaction with the computing system 130. In particular, the control of light characteristics of the lighting arrangement is responsive to the existence of a user interaction with the computing system.

In this way, presence of the user is detected by the automated lighting system by the existence of a user interaction or user activity with a computing system (e.g. rather than by user movement). This allows user presence to be reliably and continually detected, even when movement of the user is relatively small, e.g. when performing work on a computer, avoiding user frustration at lights deactivating when they are still present.

FIG. 2 illustrates a user presence sensor 100 according to an embodiment. The user presence sensor 100 comprises an acoustic sensor 101, a signal processing module 102 and an output module 103. The user presence sensor 100 may be configured to be mountable on/in a ceiling.

The acoustic sensor 101 is configured to receive sound waves W_{A}. Thus, the acoustic sensor may be a set of one or more microphones (e.g. an array of microphones) configured to generate electrical signals responsive to received sound waves. The acoustic sensor 101 is sensitive to at least parts of sound waves having the predetermined pattern, i.e. the appropriate inaudible parts of the sound waves and/or the imperceptible audio watermark.

The signal processing module 102 determines whether or not a predetermined pattern (e.g. any pattern in a set of predetermined patterns) exists in an inaudible part of each received sound wave and/or an imperceptible audio watermark exist in a received sound wave. Thus, the acoustic sensor may comprise some processing circuitry (not shown) to process received sound waves or electrical signals responsive to said sound waves to determine whether or not the predetermined pattern exists. This may comprise, for instance, processing electrical signals generated by the acoustic sensor 101 responsive to the sound waves.

In this way, the signal processing module 102 determines whether or not a computer system in the vicinity of the acoustic sensor 101 has generated a sound wave indicating the existence of an interaction between an individual and the computing system.

The precise structure and operation of the acoustic sensor 101 and the signal processing module 102 depends upon the implementation of the predetermined pattern in the inaudible part of the received sound wave and/or the imperceptible audio watermark.

For instance, if the predetermined pattern is to be a pattern (or watermark) in an ultrasound frequency of a sound wave, then the acoustic sensor may comprise a microphone sensitive to ultrasound frequencies. One example of a suitable microphone is a microelectromechanical systems (MEMS) based microphone, such as that proposed in the European Patent Application having a publication number of EP 2,271,129.

As another example, if the predetermined pattern is to be a pattern (or watermark) in an infrasound frequency of a sound wave, such as a particular low frequency modulation pattern of a sound wave, the acoustic sensor may comprise a microphone sensitive to infrasound frequencies. One example of a suitable microphone is proposed by the U.S. patent application having a publication number of US 2009/022341.

As yet another example, if the predetermined pattern is to be an imperceptible audio watermark in an audible (“acoustic”) frequency of a sound wave, the acoustic sensor may comprise a conventional microphone sensitive to frequency ranges to which a human is also sensitive (e.g. sensitive to at least frequencies between 20 Hz and 20 kHz).

The output module 103 is configured to, in response to the signal processing module 102 determining that a predetermined pattern exists in a received sound wave, generate an output signal S_{O} that is indicative of the presence of an individual in the vicinity of the user presence sensor.

In this way, the output module 103 provides an output signal S_{O} indicating whether or not there is a user interacting with a computing system in the vicinity of the acoustic sensor 101. Ibis provides a new mechanism for detecting user presence for controlling the operation of an automated lighting system.

The output signal S_{O} is therefore responsive to sound waves received at the acoustic sensor 101. In particular, the output signal is responsive to the existence or non-existence of an imperceptible predetermined pattern (or patterns) in sound waves received at the acoustic sensor, and therewith responsive to activity of a user with a complimentary computing system that generates sound waves having the predetermined pattern.

As previously explained, the output signal S_{O} is ultimately used to control an operation of one or more lighting units, and in particular, a light output by the one or more lighting units.

For instance, the output signal S_{O} could be used to control which one or more lighting units to activate (e.g. switch on) or keep activated (e.g. keep switched on)—as well as which lighting units to deactivate or keep deactivated. Thus, the control of which lighting units are activated (or which lighting units remain activated) may become dependent upon the existence of activity or interactions of the user with a computing system.

Optionally, the signal processing module 102 is further configured to generate identifying information of any identified predetermined pattern. The output module 102 is configured to include this identifying information in the output signal S_{O}. Identifying information is any suitable information that provides a (unique) identifier of the predetermined pattern, such as characteristics of the predetermined pattern unique to the predetermined pattern or information derived by demodulating/decoding (and optionally decrypting) a message or piece of information modulated and/or encoded in the predetermined pattern, e.g. in the form of an audio watermark.

The identifying information facilitates identification of information modulated and/or encoded in the form of a predetermined pattern by the computer system. In particular, different predetermined patterns may represent different pieces of information communicated from a computing system to the user presence sensor. By way of example, different predetermined patterns, e.g. different audio watermarks, may identify different computing systems and/or different users of the computing system(s).

In one example, a predetermined pattern identifies (e.g. is unique to) a computing system that generated the sound wave having the predetermined pattern. This approach facilitates identification of the computing system that generated the sound wave having the predetermined pattern, to facilitate improved or more complex control over which one or more lighting units to activate. In particular, the identifying information may be used to identify which one or more lighting units (of a larger pool of lighting units) to control responsive to the identification of the predetermined pattern.

For instance, a positional relationship between computing systems and lighting units may be known, and the identifying information could be used to identify the computing system (that generated the sound wave) and control the operation of only those lighting units in the vicinity of the computing system.

Different computing systems may be configured to generate sound waves having different predetermined patterns responsive to the existence of a user interaction/activity with the computing system. Thus, a first computing system may generate a sound wave having a first predetermined pattern (if user activity is detected), whereas a second, different computing system may generate a sound wave having a second, different predetermined pattern (if user activity is detected).

In other words, a predetermined pattern may be “unique” to a computing system. Here, “unique” means to be unique for a single instance of an automated lighting system.

The user presence sensor 100 may receive (at the acoustic sensor 101) multiple sound waves generated by different computer systems that detect user activity, each having a different predetermined pattern. The signal processing module may be configured to identify each of the different predetermined patterns, and provide identifying information for each of the identified predetermined patterns in the received sound waves. Thus, the output signal may contain identifying information for each of a plurality of different predetermined patterns (if multiple sound waves having different predetermined patterns are received at the acoustic sensor).

In another example, a predetermined pattern identifies (e.g. is unique to) a user or a characteristic of a user interacting with the computing system that generated the sound wave having the predetermined pattern. In other words, the computing system may modulate and/or encode, in the form of an imperceptible predetermined pattern, information about the user interacting with the computing system. This approach facilitates identification of the user in the vicinity of the acoustic sensor, and can allow more complex control of light output by the automated lighting system responsive to the user.

By way of example, it is generally considered that young people require less light than older people. Thus, identifying a younger user could be used to control an automated lighting system to output less light, which could lead to extra energy savings. As another example, different users may have different lighting preferences. Thus, information about the user (e.g. lighting preferences) could be transmitted to the user presence sensor for use in controlling a lighting system according to user preferences.

Characteristics of a user could be identified, for instance, based on log-in information of a user (e.g. which user has logged in) or derived using facial recognition technologies and/or interface interaction patterns.

Of course, a combination of both approaches could be used. Thus, a computing system may modulate and/or encode (as the predetermined pattern) information identifying the computing system and (a characteristic of) a user in the sound wave. The signal processing module 102 may be configured to retrieve identifying information from the predetermined pattern to facilitate identification of computing systems and/or users.

In some examples, the signal processing module is configured to process the predetermined pattern (e.g. in the form of an imperceptible audio watermark) to obtain information encoded into the sound wave by the computing system. This can be performed by appropriately demodulating, decoding or decrypting the predetermined pattern to extract the information communicated from the sound wave. This information may, for instance, be information about the computing system and/or the user. This information may be included in the output signal.

In some embodiments, the signal processing module 102 is configured to determine a distance value that is responsive to a distance between the computing system that generated a sound wave having a predetermined pattern and the acoustic sensor. Approaches for determining values responsive to a distance between a sound emitter and a sound receiver would be readily apparent to the skilled person, e.g. employing signal strength detection mechanisms, time-of-flight measures and/or use of phased array processing techniques and microphones. The acoustic sensor 101 may be configured appropriately (e.g. to have a phased array of individual sensing elements) or may communicate with other acoustic sensors (of other user presence sensors) in the vicinity to act as a phased array of sensing elements for performing a phased array processing technique.

The output module 103 may be configured to provide an indication of the determined distance value. This facilitates control of the operation of one or more lighting unit based on a distance between the user presence sensor 100 and the computing system that generated the sound wave having the predetermined pattern. This can be used, for example, to only activate (or otherwise control the output characteristics of) lights in the vicinity of the user presence sensor 100 if the computing system is within a predetermined distance of the user presence sensor 100. It can also be used, for example, the control the dimming level of the lights in the vicinity of the user presence sensor 100 in dependence of the distance between the computing system and the user presence sensor 100.

If the acoustic sensor receives multiple sound waves having imperceptible predetermined patterns from different computer systems, the signal processing module may be configured to determine a distance value for each sound wave having an imperceptible predetermined pattern.

In some embodiments, the signal processing module 102 is further configured to determine a position of the computing system that generated a sound wave having the predetermined pattern. Approaches for determining a position of the computing system that generated a sound wave may employ, for example, a phased array processing technique to identify the position of the computing system with respect to the user presence sensor 100 or the use of trilateration/triangulation procedures (e.g. making use of multiple user presence sensors to trilaterate/triangulate the position of a sound emitter). Other techniques will be apparent to the skilled person.

The output module 103 may be further configured to provide an indication of the determined position of the computing system that generated a sound wave having the predetermined pattern.

From the foregoing, it will be apparent that the content of the output signal indicates at least the existence (or not) of at least one sound wave having a predetermined pattern in an inaudible part thereof or in the form of an imperceptible audio watermark. The output signal may optionally indicate additional information about the predetermined pattern, the user of the computing system and/or the computing system that generated the predetermined pattern. The output signal may, if multiple sound waves having different imperceptible predetermined patterns are received at the acoustic sensor, contain information for each type of sound wave.

In some embodiments, the signal processing module 102 is further configured to predict the presence or absence of an individual by processing (at least audible parts of) the received waves. In particular, the received waves may be processed to identify whether a user is making noise in the vicinity of the acoustic sensor (indicating their presence in the vicinity of the acoustic sensor). Of course, signals from multiple acoustic sensors (e.g. of different user presence sensors) may be used, e.g. using a phased array technique, to identify whether the user is making noise and/or triangulate/trilaterate a location of the individual.

The output signal provided by the output module may be configured to indicate whether or not noise of an individual is detected by the signal processing module. For instance, the output signal may indicate if the amplitude of a sound wave received at the acoustic sensor exceeds some predetermined threshold. This indication may form “sound information” of the output signal.

The use of an acoustic sensor to detect noise created by an individual, as well as detecting activity with a computing system, can be used to improve the operation of the automated lighting system. Repurposing the acoustic sensor in this manner is particularly advantageous, as it does not require any additional circuitry or modules to achieve more flexibility and/or improved control over lighting units.

In some embodiments, the user presence sensor 100 may further comprise a motion sensor 105, such as a passive infrared motion sensor. The motion sensor 105 may be configured to detect a motion in the vicinity of the motion sensor 105, using approaches well known in the art. The output signal S_{O} provided by the output module 103 may be configured to further indicate whether or not motion is detected by the motion sensor 105. Thus, the output signal may further comprise motion information indicating the presence or absence of motion detected by the motion sensor.

The use of a motion sensor to detect user presence, as well as detecting user activity with a computing system, can be used to improve the operation of the automated lighting system, e.g. allowing lights to remain active as the user is moving towards a computing system or leaving the computing system, or to modify the output of lights to reflect a user activity (e.g. increase a brightness of light if no interaction with a computing system is detected, but the motion detector still detects motion), to improve a user safety and/or convenience (e.g. if they are performing non computer-based tasks).

Preferably, the receiving area or field of view (the “polar pattern”) of the acoustic sensor overlaps with the receiving area or field of view of the motion sensor. This is so that the same lighting units can be controlled for a particular position of the user via computing system interaction (via the acoustic sensor) or via motion (detected via the motion sensor).

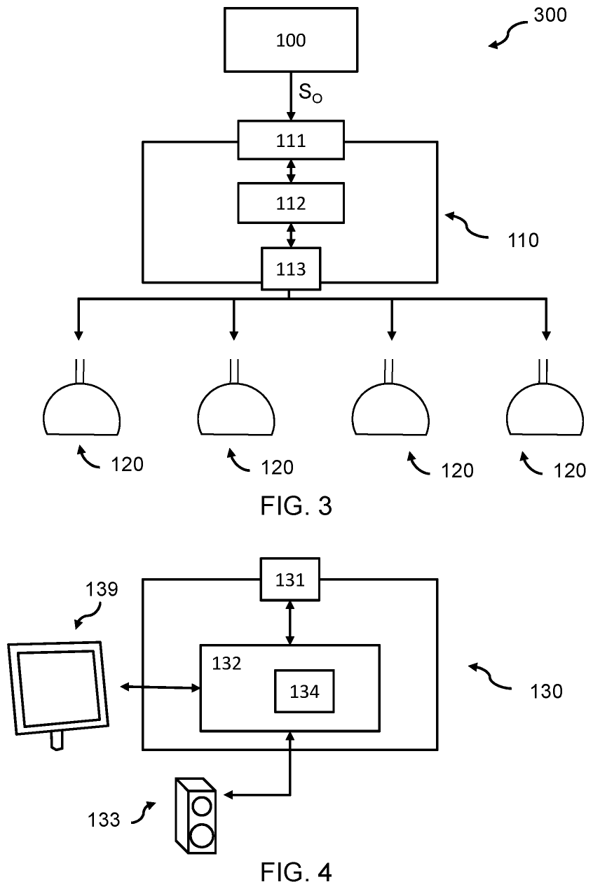

FIG. 3 illustrates an automated lighting system 300, which employs one or more sensors 100, such as those described with reference to FIG. 2.

The automated lighting system 300 comprises at least one user presence sensor 100, such as those previously described, a light control system 110 and one or more lighting units 120, each configured to controllably output light. The light control system 110 is configured to control the (light) output characteristics of one or more lighting units.

For instance, the light control system may control which lighting units are activated (e.g. switched on to output light) or deactivated (e.g. switched off to not output light). The light control system may control other output characteristics of the lighting unit(s)' light output, e.g. a color, a temperature, an angle, a light spread, a distribution and so on.

The light control system 110 controls the lighting units 120 responsive to received output signal(s) from the user presence sensor(s). The light control system 110 may, for instance, comprise an input interface 111 for receiving the output signal(s) from the user presence sensor(s), processing circuitry 112 for processing the output signal(s) to determine how to control the lighting units and an output interface 113 for generating signals for controlling the lighting unit(s).

In a simple example, an output signal S_{O} only indicates the existence or non-existence of a predetermined pattern in a sound wave (generated by a computing system). In response to the output signal S_{O} indicating the existence (or non-existence) of the predetermined pattern, the light control system 110 can control whether all connected lighting units operate in a first output mode or a second output mode.

The first output mode, which may be when the output signal S_{O} indicates the existence of the predetermined pattern, may be the activation of all connected lighting units. The second output mode, which may be when the output signal S_{O} does not indicate the existence of the predetermined pattern, may be the deactivation of all connected lighting units 120.

In other examples, the first output mode may cause the connected lighting units to emit light of a first color and/or intensity (e.g. bright white light for improved visibility) and the second output mode may cause the connected lighting units to emit light of a second, different color and/or intensity (e.g. dimmed red/green light for safety).

Using this simple example, it can clearly be seen how the existence of a predetermined pattern (and therefore of a user interaction with a computing system) can be used to control an operation of the lighting units.

Of course, more complex approaches using additional information optionally provided by the output signal S_{O} could be employed, i.e. information in addition to the existence or not of a predetermined pattern in a received sound signal.

In one example, the output signal S_{O} provides identifying information of the imperceptible predetermined pattern(s) (e.g. information effectively unique to the predetermined pattern(s)). From this identifying information, information modulated and/or encoded by the computing system into the sound wave can be determined and/or identified. This information could be used to perform more refined control of the lighting units, e.g. based on information about the computing system that generated the sound wave and/or a user of the computing system. For instance, if the predetermined pattern identifies a computing system (as indicated by the identifying information), then the identifying information could be used to control the operation of only those lighting units proximate to the identified computing system(s), i.e. control the operation of only a subset of lighting units. Information about which lighting units are proximate to different computing systems may be contained in a look-up table (stored in a separate memory), a dataset, or a set of conditional statements or according to some other policy.

As another example, if the output signal S_{O} provides distance information identifying a distance between the computing system and the acoustic sensor, then the light control system may be configured to control the operation of only those lighting units in the vicinity of the acoustic sensor if the distance is less than some predetermined value.

As a further example, if the output signal S_{O} comprises motion information (from an optional motion sensor), the light control system may be configured to control the operation of a subset of lighting units, such as those in the vicinity of the motion sensor, if motion is detected, regardless of whether the output signal indicates that no predetermined pattern exists in the received sound wave(s).

As yet another example, if the output signal S_{O} comprises position information indicating the position of the computing system, the light control system may be configured to control the operation of lighting units based on a positional relationship between the computing system and the lighting units. That is, the position of the lighting units and the computing system may be known (e.g. defined according to some known lighting configuration and/or lighting policy) and used to determine which lighting units to control.

As a yet further example, if the output signal S_{O} comprises sound information indicating the predicted presence or absence of noise generated by an individual, the light control system may be configured to control the operation of a subset of lighting units based on the sound information. For instance, if it is predicted that an individual is near an acoustic sensor based on a sound level of acoustic waves at the acoustic sensor, then lighting units near the acoustic sensor may be controlled.

Generally, the foregoing examples provide a light control system 110 configured to control lighting units based on received output signals (from one or more sensors) and a policy that defines how to control lighting units based on information in the received output signals. In particular, the policy may define which lighting units to control based on information in the received output signals and how to control the identified lighting units (e.g. define one or more light output characteristics of the lighting units).

Thus, for each lighting unit, the light control system 110 may be configured to control the operation of the lighting unit to operate in a first mode in response to the received output signal(s) indicative of a sound meeting a set of one or more predetermined criteria, and control the lighting unit to operate in a second mode in response to the received output signal(s) indicative of no sound or a sound failing to meet the set of one or more predetermined criteria.

The set of one or more predetermined criteria may be defined according to some predetermined policy, e.g. defining conditional statements (“if-then-else”), a look-up table or the like.

The light control system 110 may operate according to a timeout mechanism. In particular, the light control system may control a particular lighting unit to operate in a first mode (e.g. activate the particular lighting unit) if the received output signal(s) is(are) indicative of a sound meeting some predetermined criterion/criteria and only control the particular lighting unit to operate in a second mode (e.g. deactivate the particular lighting unit) if the received output signal(s) is(are) indicative of no sound or a sound not meeting or failing to meet the predetermined criterion/criteria for some predetermined period of time.

Elements of the user presence sensor 100 and the light control system 110 may be performed by a same overall processing unit. For instance, the signal processing module 102 of the user presence sensor and processing circuitry 112 of the light control system may be performed by a single processing unit.

FIG. 4 is a block diagram illustrating a computing system 130 for use in an embodiment.

The computing system 130 comprises a user interface 131 with which the user is able to interact. Suitable examples include a mouse, a keyboard, a trackball, a presentation pointer, a remote control, a camera (e.g. webcam), a movement sensor (e.g. for a computing system to be positioned on a moveable object, such as a chair or table), an infrared sensor (e.g. for a screen/display) and so on.

The computing system 130 also comprises a processing system 132.

In some embodiments, such as when the computing system is an existing personal computer, the processing system may be configured to process user input received at the user interface 131 and perform one or more computing tasks, e.g. to control a display 139 of the computing system, run an operating system and so on.

In other embodiments, such as when the computing system is (a part of) a user interface (e.g. (part of) the keyboard or (part of) the mouse), the processing system may be configured to forward user input receive at the user interface to another computing system. Other suitable examples will be apparent to the skilled person. For instance, the processing system may be configured to perform no further tasks than that executed by the processing module (set out below).

The computing system 130 also comprises a sound generating module 133, such as a speaker. The sound generating module 133 is configured to be controllable to emit sound waves according to a desire of the processing system 132.

The processing system 132 comprises a processing module 134, which may be implemented using software and/or hardware, that outputs control signals to control the sound generating module 133 to generate and transmit a sound wave, having a predetermined pattern in an inaudible part of the sound wave and/or in the form of an imperceptible audio watermark (which may be collectively referred to hereinafter as “imperceptible predetermined pattern” or simply “predetermined pattern”, unless specifically identified individually), in response to the user performing any interaction or activity with the computing system (via the user interface, such as typing on a keyboard or reading a display).

The processing module 134 is configured so that any interaction with the user interface by the user (e.g. any keystroke, any movement of the mouse, reading a display and so on) results in the generation of the sound wave having the imperceptible predetermined pattern. Thus, the existence of an interaction (rather than the content) defines whether or not a sound wave having the imperceptible predetermined pattern is generated.

The processing module 134 may be configured to output a control signal to bypass a volume control (if present) of the sound generating module (e.g. set by other components of the processing system) to generate the sound wave. As the generated sound wave may only have amplitude in an inaudible part or as an imperceptible audio watermark, there is no disruption to the user of the computing system and hence volume control is not essential.

The processing module 134 may be configured to generate a sound wave which repeats the predetermined pattern (e.g. in response to continued user activity). Preferably, the predetermined pattern is repeated at a frequency no greater than a predetermined maximum frequency, and may be repeated periodically at a frequency no greater than the predetermined maximum frequency. Thus, rather than generating a sound wave with the predetermined pattern in response to each user interaction, sound waves with the predetermined pattern may only be generated at periodic intervals if user activity is maintained. In other words, there may be a minimum time interval between consecutive emissions of a sound wave having the predetermined pattern.

The processing module 134 may, for example, be a piece of software installed on an existing processing system, such as a personal computer or a laptop. This advantageously makes use of existing equipment, to minimize additional cost and complexity.

The processing module 134 may be configured to modulate and/or encode information in the form of a predetermined pattern (e.g. as an imperceptible audio watermark) in an inaudible part of the sound wave. In particular, the processing module may modulate and/or encode information about the user and/or the computing system in the form of the predetermined pattern. Thus, the predetermined pattern may comprise modulated and/or encoded information, e.g. modulated or encoded according to some predetermined communication or modulation protocol.

Preferably, if information is modulated and/or encoded into the inaudible part of the sound wave or as an imperceptible audio watermark, the information is encrypted for transmission between the computing system and the user presence sensor. The user presence sensor (and/or light control system) may be configured to decrypt any encrypted information. Suitable encryption/decryption processes would be well known to the skilled person (e.g. employing conventional cryptography standards, such as AES, RSA, SHA-2 and so on).

The processing module 134 may be able to identify information about a user in a variety of ways. In one example, the processing module 134 uses log-in information of a user (e.g. from a user logging into a network) to identify the user and obtain information about the user. In another example, the processing module 134 may be able to identify (a characteristic of) a user from an interaction between the user and the user interface (e.g. using facial recognition as a user interacts with a camera or pattern recognition to identify a user pattern). As one example, a speed of typing on a keyboard could be used to infer an activity level of a user.

In some embodiments, the computing system is or comprises a peripheral for another computing system. Examples of such peripherals include: a mouse; a keyboard; a monitor and so on. The peripheral(s) may comprise some processing circuitry comprising (or running) the processing module, and a sound generating module such as a speaker. Each peripheral is capable of detecting a user interaction with the peripheral. For instance, a movement of a mouse or pressing of a key of a keyboard may be detected by a mouse and keyboard respectively. A monitor may comprise an infra-red sensor for detecting user presence, which is used for determining whether a user is interacting with the monitor (e.g. viewing content displayed by a monitor, e.g. to trigger the sensor by the exchange of thermal photons).

The disclosure makes use of a predetermined pattern in an inaudible part of a sound wave or in the form of an imperceptible audio watermark (“imperceptible predetermined pattern”). It has briefly been explained how an inaudible part of a sound wave is a part of a sound wave that is inaudible or imperceptible to human hearing, and that mechanisms for implementing an imperceptible audio watermark are known.

The imperceptible predetermined pattern may, for instance, be a predetermined pattern in an infrasound or ultrasound part of a sound wave. However, other examples of inaudible parts of a sound wave (such as based on a sound pressure of the sound wave or an intensity of the sound wave) would be apparent to the skilled person, as would methods for implementing an imperceptible audio watermark (e.g. within parts of the sound wave that are perceptible to a human).

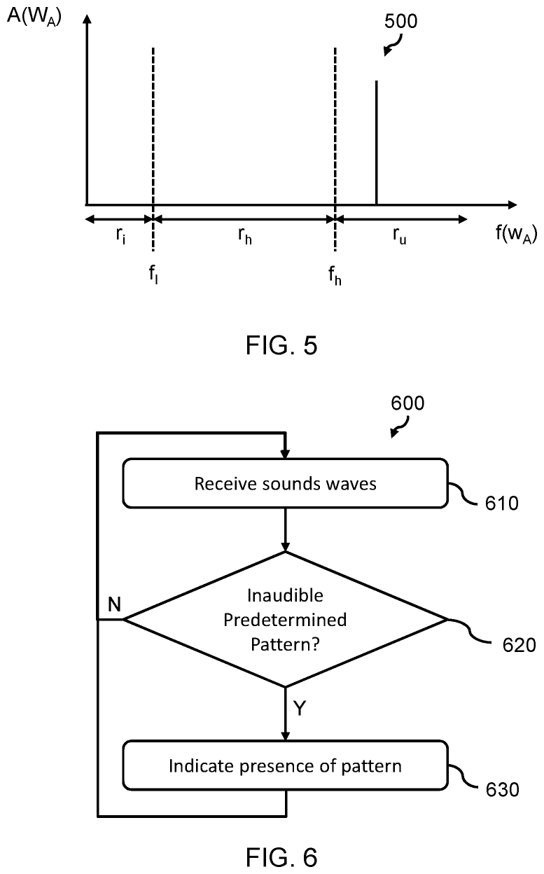

FIG. 5 is an illustration of the frequency components of a sound wave W_{A}, depicting frequency f(W_{A}) on the x-axis and amplitude of that frequency A(W_{A}) on the y-axis.

The human range of hearing rₕ falls between a low frequency value fₗ and a high frequency value fₕ. Typically, the low frequency value is considered to be around 20 Hz, and the high frequency value is considered to be around 20 kHz. The infrasound frequency range rᵢ are frequencies below the low frequency value fₗ and the ultrasound frequency range are frequencies above the high frequency value fₕ.

In some embodiments, the imperceptible predetermined pattern is a pattern of acoustic energy in the infrasound frequency range rᵢ and/or the ultrasound frequency range rᵤ. Preferably, the imperceptible predetermined pattern is a pattern of acoustic energy in the ultrasound frequency range.

A predetermined pattern (or “pattern of acoustic energy”) is any suitable arrangement of acoustic energy that provides a purposive/intentional communication (e.g. and not simply noise) through air.

One suitable example of a predetermined pattern is a burst/chirp of acoustic energy at a predetermined frequency, range of frequencies or set of frequencies. Another suitable example may be an emission of (inaudible) acoustic energy according to some predetermined temporal pattern (e.g. at a predetermined periodicity or other temporal pattern). Some predetermined patterns may combine both approaches (e.g. a temporal pattern within a predetermined frequency, range of frequencies or set of frequencies).

In the illustrated example, the predetermined pattern 500 is a (temporal) pattern at a particular frequency within the ultrasound frequency range rᵤ.

Preferably, the predetermined pattern is unique (or effectively unique) to the computing system that generates the predetermined pattern. For instance, the predetermined pattern may be based on a globally unique identifier or universally unique identifier of the computing system. This approach facilitates identification of the computing system from the imperceptible predetermined pattern, allowing for more complex lighting policies to be implemented.

Thus, the predetermined pattern for a particular computing system or processing module may be based upon a unique identifier for the computing system or processing module (such as a GUID or a UUID).

More complex predetermined patterns may employ communication or modulation protocols to encode/modulate information (e.g. identifying a user and/or computing system) in an inaudible part of a sound wave. Thus, a predetermined pattern may be a modulation pattern according to a predetermined modulation/communication protocol, for conveying information between a computing system and a user presence sensor. One example of a predetermined pattern may be information encoded/modulated using a spread-spectrum modulation protocol.

FIG. 6 illustrates a method 600 according to an embodiment. The method 600 provides an approach for sensing the presence of an individual (for an automated lighting system).

The method 600 comprises a step 610 of receiving sound waves at an acoustic sensor.

The method also comprises a step 620 of determining whether or not a predetermined pattern exists in an inaudible part of each received sound wave or as an imperceptible audio watermark. This step may be performed by a signal processing module.

In some examples, step 620 comprises determining whether or not any of a set of predetermined patterns exists in an inaudible part of each received sound wave or as imperceptible audio watermarks. Thus, different predetermined patterns may be identified.

The method also comprises a step 630 of, in response to determining that a predetermined pattern (or one of the set of predetermined patterns) exists in a received sound wave, generating an output signal that indicates the presence of an individual in the vicinity of the acoustic sensor.

If no predetermined pattern (or none of the set of predetermined patterns) are detected, then the method reverts back to step 610.

For the method 600, sound waves having the predetermined pattern (or one or the set of predetermined patterns) are generated by a computing system in response to the individual interacting with the computing system.

As discussed above, embodiments make use of a processing module. The processing module can be implemented in numerous ways, with software and/or hardware, to perform the various functions required. A processor is one example of system that employs one or more microprocessors that may be programmed using software (e.g., microcode) to perform the required functions for a processing module. A processing module may however be implemented with or without employing a processor, and also may be implemented as a combination of dedicated hardware to perform some functions and a processor (e.g., one or more programmed microprocessors and associated circuitry) to perform other functions. Disclosed methods are preferably computer-implemented methods.

Examples of processing module components that may be employed in various embodiments of the present disclosure include, but are not limited to, conventional microprocessors, application specific integrated circuits (ASICs), analogue electronics, and field-programmable gate arrays (FPGAs).

In various implementations, a processor or processing module may be associated with one or more storage media such as volatile and non-volatile computer memory such as RAM, PROM, EPROM, and EEPROM. The storage media may be encoded with one or more programs that, when executed on one or more processors, perform the required functions. Various storage media may be fixed within a processor or processing module or may be transportable, such that the one or more programs stored thereon can be loaded into a processor or processing module.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage. If the term “adapted to” is used in the claims or description, it is noted the term “adapted to” is intended to be equivalent to the term “configured to”. Any reference signs in the claims should not be construed as limiting the scope.

1. A kit of parts comprising:
a user presence sensor for an automated lighting system, the user presence sensor comprising:
an acoustic sensor configured to receive sound waves,
a signal processing module configured to determine whether or not a predetermined pattern exists in an inaudible part of received sound waves and/or as an imperceptible audio watermark, and
an output module configured to, in response to the signal processing module determining that a predetermined pattern exists in a received sound wave, generate an output signal that indicates the presence of an individual in the vicinity of the acoustic sensor, and
a processing module for a computing system, the processing module being configured to
receive, from an input interface, an indication whether or not a user is interacting with the computing system, and
output a control signal to control a sound generating module to generate and transmit the sound wave, having the predetermined pattern in an in audible part of the sound wave and/or as an imperceptible audio watermark,
in response to the user interacting with the computing system; and
a sound generating module for generating and transmitting the sound wave.

2. The kit of parts of claim 1, wherein the inaudible part of the received sound waves comprises an ultrasound and/or infrasound part.

3. The kit of parts of claim 1, wherein the predetermined pattern is a modulation pattern.

4. The kit of parts of claim 1, wherein:
the signal processing module is configured to, in response to the acoustic sensor determining that a predetermined pattern exists in a received sound wave, generate identifying information of the predetermined pattern determined to exist in each received sound wave; and
the output module is configured to generate the output signal to provide the generated identifying information.

5. The kit of parts of claim 1, wherein:
the signal processing module is further configured to, for sound waves having the predetermined pattern, determine a distance value responsive to a distance between the computing system that generated the sound wave having a predetermined pattern and the acoustic sensor; and
the output module is further configured to, in response to the acoustic sensor determining that a predetermined pattern exists in a received sound wave, provide an indication of the determined distance value between the computing system that generated the sound wave having the predetermined pattern and the acoustic sensor.

6. The kit of parts claim 1, wherein:
the signal processing module is further configured to, for sound waves having the predetermined pattern, determine a position of the computing system that generated the sound wave having the predetermined pattern;
the output module is further configured to, in response to the acoustic sensor determining that a predetermined pattern exists in a received sound wave, provide an indication of the determined position of the computing system that generated the sound wave having the predetermined pattern.

7. An automated lighting arrangement comprising:
a kit of parts according to claim 1,
one or more lighting units configured to controllably output light; and
a light control system configured to receive the output signal from the user presence sensor and control the operation of the one or more lighting units responsive to the output signal.

8. The automated lighting arrangement of claim 7, wherein the light control system is configured to determine which of the one or more lighting units to control responsive to the identifying information of the predetermined pattern in the output signal.

9. The automated lighting arrangement of claim 8, wherein the light control system is configured to:
process the identifying information to identify the computing system that generated the sound wave having the predetermined pattern; and
select which one or more lighting units to control responsive to the identified computing system.

10. The automated lighting arrangement of claim 7, wherein the light control system is configured to control the one or more lighting units responsive to the determined distance between the computing system that generated the sound wave having the predetermined pattern and the user presence sensor; wherein the light control system is configured to select which of the one or more lighting units to control responsive to the determined position of the computing system that generated the sound wave having the predetermined pattern and the user presence sensor.

11. (canceled)

12. (canceled)

13. (canceled)

14. The automated lighting arrangement according to claim 8 comprising a plurality of processing modules.

15. A computer-implemented method of sensing the presence of an individual, the method comprising:
receiving, from an input interface, and indication of whether or not a user is interacting with a computing system,
outputting a control signal to control a sound generating module to generate and transmit a sound wave, having a predetermined pattern in an inaudible part of the sound wave and/or as a imperceptible audio watermark, in response to the user interacting with the computing system,
generating, by the sound generating module, the sound wave,
receiving, at an acoustic sensor, sound waves;
determining whether or not the predetermined pattern exists in an inaudible part of each received sound wave and/or as an imperceptible audio watermark; and
in response to determining that thia predetermined pattern exists in a received sound wave, generating an output signal that indicates the presence of an individual in the vicinity of the acoustic sensor.

16. The kit of parts of claim 1, wherein the processing module is configured to output the control signal to control the sound generating module to generate and transmit a sound wave having the predetermined pattern in an inaudible part of the sound wave, wherein the predetermined pattern is repeated at a frequency no greater than a predetermined maximum frequency.

17. The automated lighting arrangement of claim 9, wherein the light control system is configured to control the one or more lighting units responsive to the determined distance between the computing system that generated the sound wave having the predetermined pattern and the user presence sensor; wherein the light control system is configured to select which of the one or more lighting units to control responsive to the determined position of the computing system that generated the sound wave having the predetermined pattern and the user presence sensor.
